(19) United States
(12) Patent Application Publication
(10) Pub. No.: US 2025/0390396 A1
(43) Pub. Date: Dec. 25, 2025

(54) METHOD AND SYSTEM FOR FILE RECOVERY BASED ON MULTIPLE SNAPSHOTS

(71) Applicant: Delta Electronics, Inc., Taoyuan City (TW)

(72) Inventors: Shen Ming CHUNG, Taoyuan City (TW); Tzi Cker CHIUEH, Taoyuan City (TW)

(73) Assignee: Delta Electronics, Inc., Taoyuan City (TW)

(21) Appl. No.: 19/207,460

(22) Filed: May 14, 2025

(30) Foreign Application Priority Data
Jun. 21, 2024 (CN) 202410808029.6

(51) Int. Cl. G06F 11/14

(52) U.S. Cl. CPC G06F 11/1469

(57) ABSTRACT

Provided is a method and system for file recovery based on multiple snapshots. During each time data are backing up for a snapshot, each backup file thereof is scanned to see if it is potentially damaged by ransomware, and if yes, marked as suspicious. For example, during subsequent backup processes, a first file list and a second file list with files that may be marked as suspicious files are generated. When there is a need to perform data recovery, file(s) marked as suspicious in the second file list is/are replaced with corresponding file(s) in the first file list that is/are not marked as suspicious, in order to generate a candidate file list. The file recovery is performed according to the candidate file list. This method prevents the files that are damaged by ransomware from being recovered to a target device and saves the time required for data recovery.

### CROSS REFERENCE TO RELATED APPLICATION

This application claims the benefit of priority of Chinese Patent Application No. 202410808029.6, filed on Jun. 21, 2024, the contents of which are incorporated by reference as if fully set forth herein in their entirety.

### TECHNICAL FIELD

Embodiments of the present application relate to data management, and more particularly to a method and system for file recovery based on multiple snapshots.

### BACKGROUND

Ransomware is a type of malicious software that usually destroys a victim's data by encrypting the data such that the user cannot access his or her files normally. Once the files are encrypted, the attacker will ask for a certain amount of ransom to decrypt the files. This results in financial stress for the victim, and even if the ransom is paid, it cannot guarantee that the data will be recovered completely. For data security, it is crucial to enhance protection and coping capabilities against ransomware.

To resist ransomware attacks, backup solutions have become an important last line of defense for businesses and government agencies. However, traditional backup solutions are insufficient in resisting ransomware because it is unknown whether the backed-up files are “clean”. When there is a need to restore data, it often takes more time to inspect file content manually from multiple backup snapshots in the past.

In addition, traditional solutions to resist virus infection cannot be applied to prevent ransomware attacks since ransomware has its particularity. Traditional antivirus software uses a virus definition database to detect and isolate known viruses and must regularly update the virus definition database to identify new virus variants. If a file is infected by a virus, it usually needs to be quarantined. Sometimes it is possible to remove the virus from the infected file. However, if a file is damaged by ransomware, the content of the file often suffers massive destruction by an encryption algorithm. Without the original encryption key, the file cannot be recovered by decrypting the content. Therefore, if a file is damaged by ransomware, in practice it is necessary to have the file backed up in advance to increase the possibility of having the encrypted data recovered. Therefore, the solutions to resist viruses cannot be used to overcome the threat of ransomware.

In the aspect of data recovery for ransomware, there are two types of conventional techniques. The first type is data restoration from a single snapshot, and the second type is data restoration from multiple snapshots.

Regarding data restoration from a single snapshot, the most straightforward way is to restore files from the latest snapshot. Another way is to observe the operating system and estimate the time point when the system is attacked by ransomware (for example, detecting the ransomware by detecting whether there is an abnormal increase in file access or setting up a honeypot) and perform the file restoration by manually or automatically selecting one of the snapshots before the time point of attack. However, this approach cannot thoroughly ensure whether the snapshot used for restoration is clean. It is possible that the restored data still contain files that are damaged by ransomware. Users still have to spend time manually inspecting the restored files to ensure that each file is in a “clean” state, just like it was before being attacked.

Regarding data restoration from multiple snapshots, multiple snapshots are mounted and scanned one by one to find the files in each snapshot that have not been damaged by ransomware, and then the modification dates of these files are compared, and the data restoration is performed according to the latest files that have not been damaged by ransomware. However, this approach (i.e., mounting the snapshots one by one to be scanned) takes a lot of time and cannot satisfy the demand for rapid data restoration. It is urgent to quickly recover files especially when an enterprise is attacked.

Therefore, there is a need to improve and optimize existing file recovery approaches.

### SUMMARY

Embodiments of the present application provide a method and system for file recovery based on multiple snapshots, which are capable of improving the efficiency of data recovery. The technical solutions provided in the present application are described below.

In accordance with one aspect of the embodiments of the present application, a method for file recovery based on multiple snapshots is provided, including receiving multiple files stored on an endpoint device, backing up the files into a first snapshot, and storing a first file list corresponding to the first snapshot; detecting whether a file format of each file is damaged when backing up the first snapshot, and if the file format of a file is damaged, marking the file in the first file list as suspicious; receiving multiple files stored on the endpoint device, backing up the files into a second snapshot, and storing a second file list corresponding to the second snapshot; detecting whether the file format of each file is damaged when backing up the second snapshot, and if the file format of a file is damaged, marking the file in the second file list as suspicious; accessing the first file list and the second file list when a restoration request is received from the endpoint device, and replacing the file marked as suspicious in the second file list with a corresponding file not marked as suspicious in the first file list to generate a candidate file list; and in response to the restoration request, transmitting the candidate file list to the endpoint device to perform file recovery according to the candidate file list.

In an embodiment of the present application, the method further includes detecting whether there is a file associated with the suspicious file in the second file list; detecting whether a file corresponding to the associated file in the first file list is not marked as suspicious; and replacing the associated file in the second file list with the corresponding file that is not marked as suspicious in the first file list to generate the candidate file list.

In an embodiment of the present application, the associated file refers to a file based on one of or a combination of at least two of the following characteristics: a file located in the same folder, a file of relevant type, a file with dependency, and a file that is modified during the same period.

In an embodiment of the present application, the method further includes detecting files in the endpoint device according to the candidate file list to check if the file format of each corresponding file in the endpoint device is not damaged, and if so, optimizing out one or more corresponding files from the candidate file list; and performing the file recovery according to the optimized candidate file list.

In an embodiment of the present application, detecting whether the file format of the file is damaged or whether the file is suspicious is based on at least one of the following: whether the file can be opened by a software application; whether the file can be parsed by a file parser; and whether file content entropy of the file is too high.

In an embodiment of the present application, the method further includes restoring the files from the snapshots to the endpoint device according to the candidate file list.

In an embodiment of the present application, the method further includes restoring the files from the snapshots to a second endpoint device other than the endpoint device according to the candidate file list.

In an embodiment of the present application, the method further includes, if a file in the second file list is marked as suspicious, receiving a third file list corresponding to a third snapshot; merging the file not marked as suspicious in the third file list into the candidate file list to generate an updated candidate file list; and in response to the restoration request, transmitting the updated candidate file list to the endpoint device.

In an embodiment of the present application, in order to preserve the situation where the file(s) of the endpoint device is/are damaged, the method further includes, if backup file(s) retrieved from the snapshots is/are going to overwrite one or more files of the endpoint device during restoration, copying the one or more files to another folder in advance.

In an embodiment of the present application, in order to preserve the situation where the file(s) of the endpoint device is/are damaged, the method further includes placing backup file(s) retrieved from the snapshots into a different folder to prevent overwriting one or more original files of the endpoint device.

In accordance with another aspect of the embodiments of the present application, a system for file recovery based on multiple snapshots is provided, including a processor; and a memory connected to the processor, storing a plurality of instructions that can be executed by the processor to receive multiple files stored on an endpoint device, back up the files into a first snapshot, and store a first file list corresponding to the first snapshot; detect whether a file format of each file is damaged when backing up the first snapshot, and if the file format of a file is damaged, mark the file in the first file list as suspicious; receive multiple files stored on the endpoint device, back up the files into a second snapshot, and store a second file list corresponding to the second snapshot; detect whether a file format of each file is damaged when backing up the second snapshot, and if the file format of a file is damaged, mark the file in the second file list as suspicious; access the first file list and the second file list when a restoration request is received from the endpoint device, and replace the file marked as suspicious in the second file list with a corresponding file not marked as suspicious in the first file list to generate a candidate file list; and in response to the restoration request, transmit the candidate file list to the endpoint device to perform file recovery according to the candidate file list.

In an embodiment of the present application, the plurality of instructions are executed by the processor to detect whether there is a file associated with the suspicious file in the second file list; detect whether a file, corresponding to the associated file, in the first file list is not marked as suspicious; and replace the associated file in the second file list with the corresponding file that is not marked as suspicious in the first file list to generate the candidate file list.

In an embodiment of the present application, the associated file refers to a file based on one of or a combination of at least two of the following characteristics: a file located in a same folder, a files of relevant type, a file with dependency, and a file that is modified during a same period.

In an embodiment of the present application, the plurality of instructions are executed by the processor to detect files in the endpoint device according to the candidate file list to check if the file format of each corresponding file in the endpoint device is not damaged, and if so, optimize out one or more corresponding files from the candidate file list; and perform the file recovery according to the optimized candidate file list.

In an embodiment of the present application, detecting whether the file format of the file is damaged or whether the file is suspicious is based on at least one of the following: whether the file can be opened by a software application; whether the file can be parsed by a file parser; and whether file content entropy of the file is too high.

In an embodiment of the present application, the plurality of instructions are executed by the processor to restore the files from the snapshots to the endpoint device according to the candidate file list.

In an embodiment of the present application, the plurality of instructions are executed by the processor to restore the files from the snapshots to a second endpoint device other than the endpoint device according to the candidate file list.

In an embodiment of the present application, the plurality of instructions are executed by the processor to, if the file in the second file list is marked as suspicious, receive a third file list corresponding to a third snapshot; merge the file not marked as suspicious in the third file list into the candidate file list to generate an updated candidate file list; and in response to the restoration request, transmit the updated candidate file list to the endpoint device.

In an embodiment of the present application, in order to preserve the situation where the file(s) of the endpoint device is/are damaged, the plurality of instructions are executed by the processor to copy a damaged file to another folder in advance if a backup file retrieved from the snapshots is going to overwrite the damaged file during restoration.

In an embodiment of the present application, in order to preserve the situation where the file(s) of the endpoint device is/are damaged, the plurality of instructions are executed by the processor to place a backup file retrieved from the snapshots into a folder different from the damaged file on a local side to avoid overwriting one or more original files of the endpoint device.

The technical solutions provided in the embodiments of the present application may provide beneficial effects as follows.

In the method and system for file recovery based on multiple snapshots in the embodiments of the present application, whenever data are backing up, each backup file is scanned to mark files damaged by ransomware as suspicious. For example, during two data backup processes, a first file list that may have suspicious file marks and a second file list that may have suspicious file marks are generated. Then, when data recovery is needed, the first file list and the second file list are accessed, and the file marked as suspicious in the second file list is replaced with a corresponding file not marked as suspicious in the first file list to generate a candidate file list. Then, file recovery can be performed according to the generated candidate file list. Since suspicious files are marked in advance before data restoration, files that may have been damaged by ransomware can be avoided during restoration to a target device. Furthermore, since a list of candidate files excluding the suspicious files can be quickly obtained for data restoration, the time needed for data recovery and the human effort required are greatly reduced.

### BRIEF DESCRIPTION OF THE DRAWINGS

For explaining the technical solutions used in the embodiments of the present application more clearly, the following figures are briefly introduced to describe the embodiments. Obviously, the figures described below are only some of the embodiments of the present application, and those of ordinary skill in the art can further obtain other figures based on these figures without making any inventive effort.

FIG. 1 is a block diagram of a system for file recovery based on multiple snapshots according to an embodiment of the present application.

FIG. 2 is a flowchart of a method for file recovery based on multiple snapshots according to an embodiment of the present application.

FIG. 3 is schematic diagram illustrating a process of generating a candidate file list according to an embodiment of the present application.

FIG. 4 is a schematic diagram illustrating a process of data restoration according to an embodiment of the present application.

FIG. 5 is flowchart of a method of generating a candidate file list according to an embodiment of the present application.

FIG. 6 is schematic diagram illustrating another process of generating a candidate file list according to an embodiment of the present application.

FIG. 7 is flowchart of a method of optimizing a candidate file list according to an embodiment of the present application.

FIG. 8 is schematic diagram illustrating a process of optimizing a candidate file list according to an embodiment of the present application.

FIG. 9 is flowchart of a method of updating a candidate file list according to an embodiment of the present application.

10 system for file recovery based on multiple snapshots
11 backup module
12 list generating module
13 restoration module
30 candidate file list
40 source storage area
110 backup unit
120 detecting unit
130 marking unit
F01˜F04 files
F11˜F14 files
F21˜F24 files
S0 snapshot
S1 first snapshot
S2 second snapshot
S20˜S29 steps
S50˜S52 steps
S70˜S71 steps
S91˜S93 steps

### DETAILED DESCRIPTION

The technical solutions in the embodiments of the present application will be clearly and completely described below with reference to the figures in the embodiments of the present application. Obviously, the described embodiments are merely some embodiments of the present application and do not represent all of the embodiments. According to the embodiments of the present application, all other embodiments obtained by those of ordinary skill in the art without making any inventive effort are within the scope of protection sought in the present application.

Embodiments of the present application provide a backup solution to prevent ransomware attacks. In particular, during each time data are backed up, the content of each backup file is scanned to mark a file damaged by ransomware as suspicious. Therefore, when data are to be restored from multiple snapshots, a list of candidate files excluding suspicious files can be quickly obtained for data restoration. This greatly saves the time needed for data restoration and improves the efficiency of data recovery. Moreover, since it can be known whether each backup file is a suspicious file, it can effectively avoid a situation where the restored data still contain files encrypted by ransomware.

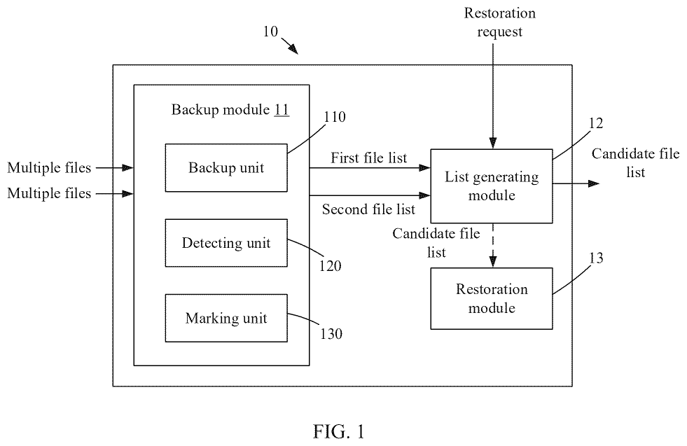

FIG. 1 is a block diagram of a system 10 for file recovery based on multiple snapshots according to an embodiment of the present application. As shown in FIG. 1, the system 10 includes a backup module 11, a list generating module 12 and a restoration module 13. The backup module 11 may further include a backup unit 110, a detecting unit 120 and a marking unit 130. The list generating module 12 is connected between the backup module 11 and the restoration module 13.

The system 10 can be implemented using software or firmware operating in individual hardware or can be implemented using any combination of any two or more than two of hardware, software, and firmware. In an embodiment of the present application, the backup module 11, the list generating module 12, and the restoration module 13 may be software modules implemented by program codes. A server (e.g., a cloud-based storage server) in a computer environment or a computer device with a processor and a memory can be used to run the system 10 in an embodiment of the present application to mark the files damaged by ransomware as suspicious during data backup and then quickly exclude these suspicious files during data restoration.

The backup module 11 is used for data backup. Specifically, the backup unit 110 of the backup module 11 can back up one or more files from an endpoint device into a snapshot and generate a file list corresponding to these files. During the backup process, the detecting unit 120 detects whether the file format of each file is damaged (for example, detecting whether the file can be opened by a software application, making a comparison of whether a previous version of the file can be opened by the software application, detecting whether the file can be parsed by a file parser, making a comparison of whether a previous version of the file can be parsed by the file parser, detecting whether the file content entropy of the file is too high, and making a comparison of whether the file content entropy of a previous version of the file is too high). If the file format of a file is damaged, it may be a file that has been attacked by ransomware and can be considered suspicious. When the detecting unit 120 detects that the file format of a file is damaged, the marking unit 130 marks the file in the file list as suspicious.

The backup module 11 performs the aforementioned process each time data are backed up. For example, during a data backup process performed at a first time point, the backup unit 110 receives one or more files stored in the endpoint device, backs up the files into a first snapshot and stores a first file list corresponding to the first snapshot; during another data backup process performed at a second time point, the backup unit 110 receives one or more files stored in the same endpoint device, backs up the files into a second snapshot and stores a second file list corresponding to the second snapshot. For example, the second time point is later than the first time point, that is, the first snapshot is a snapshot that was backed up earlier, and the second snapshot is a snapshot that was backed up later. When the backup unit 110 backs up the first snapshot, the detecting unit 120 detects whether the file format of each file is damaged. If the file format of a file is damaged, the marking unit 130 marks the file as suspicious in the first file list. When the backup unit 110 backs up the second snapshot, the detecting unit 120 detects whether the file format of each file is damaged. If the file format of a file is damaged, the marking unit 130 marks the file as suspicious in the second file list. Of course, data backup is not limited to the two backup processes described above, and there may have other backup processes. The aforementioned two backup processes are for illustrative purpose only.

When a user wants to perform data recovery, the system 10 will receive a restoration request from the user. In response to the restoration request, the list generating module 12 receives the first file list and the second file list from the backup module 11 and generates a candidate file list 30 based on the first file list and the second file list such that subsequent data restoration operations can be implemented according to this candidate file list 30. It should be noted that if suspicious file marks are included in the first file list and/or the second file list, the file lists received by the list generating module 12 from the backup module 11 will also include the suspicious file marks.

In the process of generating candidate files, the list generating module 12 replaces the file marked as suspicious in the second file list with a corresponding file not marked as suspicious in the first file list. That is, if it is found that there is a suspicious file that may be damaged by ransomware in the second snapshot with a later backup time, the list generating module 12 can find an undamaged version of the file from a snapshot (e.g., the first snapshot) with an earlier backup time. The undamaged version of the file is recorded in the candidate file list 30, and in the subsequent data restoration process, the undamaged version is used for restoration. If the list generating module 12 cannot find an undamaged version of the file from a snapshot with earlier backup time, the list generating module 12 may remove the file from the candidate file list 30 to prevent the file damaged by ransomware from being restored to the endpoint device. The modification time or creation time of a file (i.e., a normal file) that is not marked as suspicious in the second file list may be later than that of a corresponding file in the first file list. Accordingly, the normal file in the second file list is recorded in the candidate file list 30 such that data can be recovered using a file version that is closer to current point time.

As mentioned above, the system 10 includes the restoration module 13. According to the candidate file list 30, the restoration module 13 is used to restore candidate files recorded in the candidate file list 30. For example, the restoration module 13 can restore the candidate files to the endpoint device. The endpoint device can be cloud-based storage or local storage. The restoration module 13 can help the endpoint device retrieve the files to be restored from multiple snapshots according to the candidate file list 30 and can transmit these files to the endpoint device. In other embodiments, the restoration module 13 can also restore the files from the snapshots to a second endpoint device, different from the endpoint device according to the candidate file list 30.

Of course, the restoration module 13 may be omitted from the system 10. In response to the restoration request of the endpoint device, only the candidate file list 30 is transmitted to the endpoint device. The endpoint device may review the candidate files to be restored, recorded in the candidate file list 30, and, if necessary, modify or adjust the candidate files to be restored. The file restoration is performed according to the confirmed candidate files.

The above description of the system 10 pertains only to certain embodiments of the present application, and is not intended to be limiting. The embodiments introduced below, as well as those described in conjunction with flowcharts, should also be regarded as embodiments applicable to operations within the system 10.

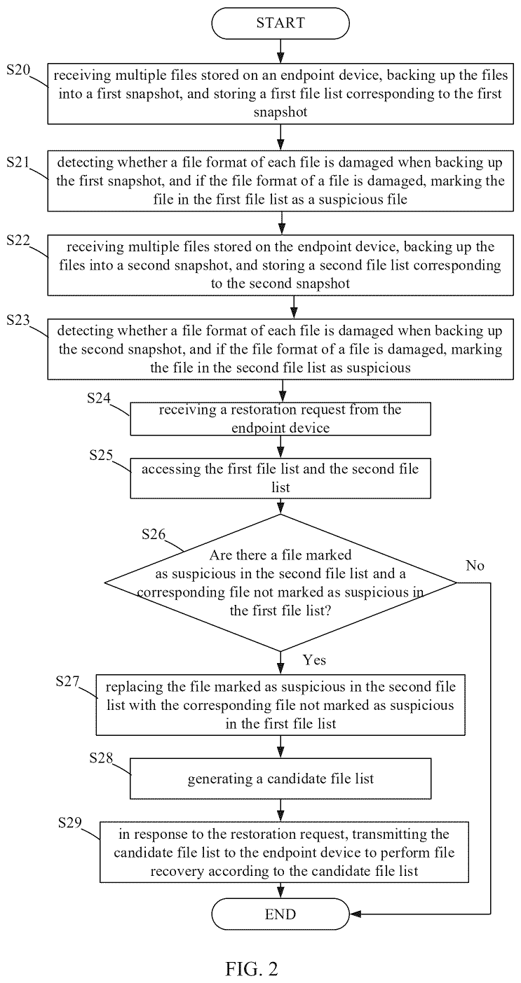

FIG. 2 is a flowchart of a method for file recovery based on multiple snapshots according to an embodiment of the present application. The method for file recovery disclosed in FIG. 2 may be implemented in conjunction with the system 10 illustrated in FIG. 1.

As shown in Steps S20 to S23 of FIG. 2, whenever the backup module 11 performs data backup, it generates a file list corresponding to a snapshot, detects whether a backup file is suspicious of being damaged by ransomware, and marks the suspicious file in the file list.

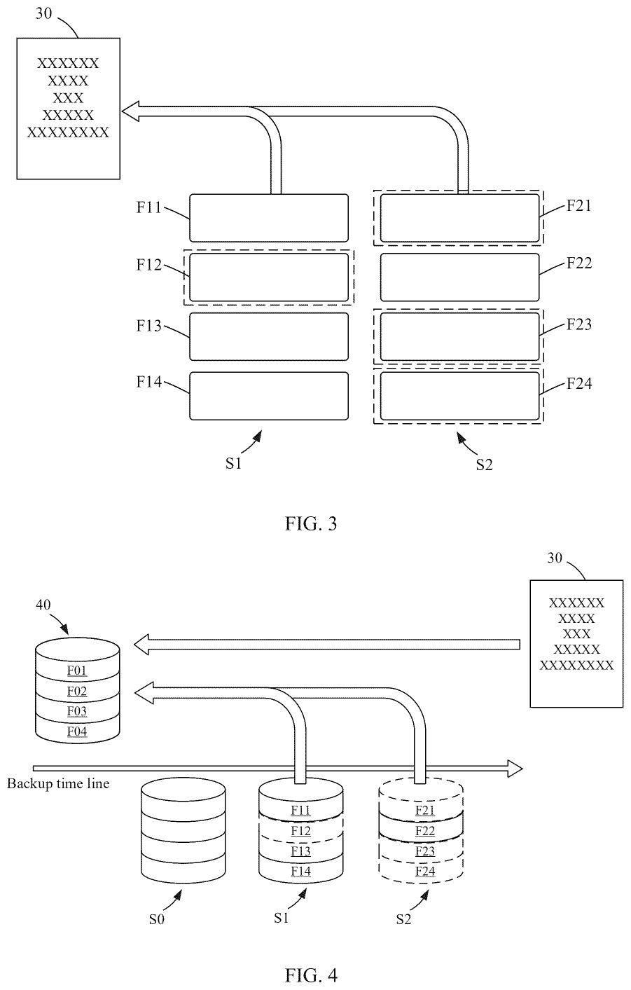

Taking two data backup processes (regarding data backup, there may have other backup processes, without being limited to the two processes) as an example, please refer to FIG. 2 along with FIG. 3. In an earlier data backup process, the backup unit 110 receives multiple files stored on the endpoint device, backs up the files into a first snapshot S1 and stores a first file list corresponding to the first snapshot S1 (Step S20). As shown in FIG. 3, files F11, F12, F13, and F14 are recorded in the first file list. During the backup unit 110 backs up the first snapshot S1, the detecting unit 120 detects whether the file format of each file is damaged. If the file format of a file is damaged, the marking unit 130 marks the file as suspicious in the first file list (Step S21). As shown in FIG. 3, in this example, all the files F11, F12, F13, and F14 are normal files and are not suspicious files. In a later data backup process, the backup unit 110 receives multiple files stored on the same endpoint device, backs up the files into a second snapshot S2 and stores a second file list corresponding to the second snapshot S2 (Step S22). As shown in FIG. 3, files F21, F22, F23, and F24 are recorded in the second file list. During the backup unit 110 backs up the second snapshot S2, the detecting unit 120 detects whether the file format of each file is damaged. If the file format of a file is damaged, the marking unit 130 marks the file as suspicious in the second file list (Step S23). As shown in FIG. 3, in this example, the file F22 is a suspicious file, and the files F21, F23, and F24 are all normal files and are not suspicious files.

It should be noted that whether the file format of a file is damaged can be determined by detecting whether the file can be opened by a corresponding software application, or by detecting whether the file can be parsed by a file parser, or by detecting whether the file content entropy of the file is too high, or by a combination of the above approaches or any other detection approaches. However, detecting whether a file is damaged is not what the present invention focus on. Several embodiments are listed only for illustrative purposes, but the present application is not limited thereto. If the file format of the file is damaged, it would be a file that has been attacked by ransomware and can be marked as suspicious.

In an embodiment of the present application, during each time data are backed up, each backup file is scanned so as to mark the file damaged by ransomware as suspicious. Even though it takes a certain amount of time to make suspicious file marks during data backup as compared with traditional backup process, this is beneficial in avoiding restoring the files that may be damaged by ransomware to a target device during the subsequent data restoration process. It saves the time required in waiting for data restoration at critical moments. In some scenarios, it is urgent to perform the data restoration, and being able to shorten the time required for data restoration would be helpful. The extra time required for the backup is usually taken in the background. Since the user's time requirement for regular data backup is much lower than the time requirement for data restoration performed when being attacked, this complies with the scenarios in general situations.

When the system 10 receives a restoration request from the endpoint device (Step S24), it means the user wants to perform data restoration. At this time, the list generating module 12 accesses the first file list corresponding to the first snapshot S1 and the second file list corresponding to the second snapshot S2 (Step S25) and generates a candidate file list 30 based on the first file list and the second file list. For a file marked as suspicious in the second file list, the list generating module 12 determines whether the file is not marked as suspicious in the first file list (if the first file list also has the file) (Step S26). If yes, the list generating module 12 replaces the file marked as suspicious in the second file list with a corresponding file not marked as suspicious in the first file list (Step S27), and the candidate file list 30 is generated according to such a rule (Step S28). In order to illustrate the steps in the present invention more clearly, FIG. 3 can be taken as an example. The file F22 is marked as suspicious in the second snapshot S2, while a corresponding file F12 is not marked as suspicious in the first snapshot S1. As a result, the suspicious file F22 in the second snapshot S2 will be replaced by the normal file F12 in the first snapshot S1, which is recorded in the candidate file list 30. That is, if it is found that there is a suspicious file (e.g., the file F22) that may be damaged by ransomware in the second snapshot with a later backup time, the list generating module 12 can find an undamaged version of the file (e.g., the file F12) from a snapshot (e.g., the first snapshot S1) with an earlier backup time, and the undamaged version of the file is recorded in the candidate file list 30.

In Step S29, the candidate file list 30 generated by the list generating module 12 will be provided or transmitted to the endpoint device in response to the restoration request such that the endpoint device can perform file restoration according to the candidate file list 30. Specifically, the endpoint device retrieves the files to be restored from the actual storage space of each of the snapshots (e.g., the first snapshot S1 and the second snapshot S2) according to the candidate files recorded in the candidate file list 30 to accomplish the data restoration. If necessary, the endpoint device may modify or adjust the candidate files to be restored according to the candidate file list 30 for the data restoration.

In order to illustrate the steps in the present invention more clearly, FIG. 4 can be taken as an example. A source storage area 40 is attached to an endpoint device. The snapshot SO is the whole backup of the source storage area 40. The first snapshot S1 and the second snapshot S2 are backups taken at a first time point and a second time point, respectively. The snapshots S1 and S2 include (but are not limited to) the files modified or added at the first time point and the second time point with respect to the whole backup. The actual storage space of the snapshots SO, S1 and S3 may be different from the source storage area 40. Following the aforementioned example, the file F22 in the second snapshot S2 is marked as suspicious, and thus the candidate file list 30 records the files F21, F23, and F24 of the second snapshot S2 and the file F12 of the first snapshot S1. All the files F01, F02, F03, and F04 in the source storage area 40 are files damaged by ransomware. They are all the files that need to be restored. The files recorded in the candidate file list 30 are all “clean” (that is, not damaged) files. Therefore, according to the files recorded in the candidate file list 30, relevant files can be retrieved from corresponding snapshots to recover the damaged files in the source storage area 40.

In other embodiments, the aforementioned method may further include a step of restoring the files from the snapshots (e.g., the first snapshot S1 and the second snapshot S2) to the endpoint device according to the candidate file list 30. Specifically, the restoration module 13 can help the endpoint device retrieve the files to be restored from multiple snapshots according to the candidate file list 30 and can transmit these files to the endpoint device. In this way, quick data recovery or automatic recovery can be achieved. In other embodiments, the aforementioned method may further include a step of restoring the files from the snapshots (e.g., the first snapshot S1 and the second snapshot S2) to a second endpoint device other than the endpoint device according to the candidate file list 30. Specifically, the restoration module 13 can restore the files from the snapshots to the second endpoint device other than the endpoint device according to the candidate file list 30. In this way, remote restoration can be achieved. Recovery from a remote site often occurs in a scenario where the endpoint device is attacked by ransomware, and it has to be in forensic procedures and cannot be put online immediately.

In other embodiments, when the restoration module 13 performs data restoration, if a backup file retrieved from the snapshots is going to overwrite the damaged file, the damaged file can be copied to another folder in advance. For example, the damaged file can be copied to a quarantine area, and access to the damaged file is made restricted, in order to preserve the situation where the file of the endpoint device is damaged. In addition, making a copy of the damaged file and copying it to another folder can also preserve the file, preventing a result of data loss when the file is misjudged as damaged. In other embodiments, the restoration module 13 can place a backup file retrieved from the snapshots into a folder different from the damaged file. In this way, before an original folder containing the damaged file is overwritten, one can check in advance whether a result of the file restoration is as expected.

In the method and system for file recovery according to multiple snapshots in the embodiments of the present application, whenever data are backed up, each backup file is scanned to mark the file damaged by ransomware as suspicious. For example, during two data backup processes, a first file list that may have suspicious file marks and a second file list that may have suspicious file marks are generated. Then, when it is necessary to perform data recovery, the first file list and the second file list are accessed, and the file marked as suspicious in the second file list is replaced with a corresponding file not marked as suspicious in the first file list to generate a candidate file list. Then, file recovery can be performed based on the generated candidate file list. Since suspicious files are marked in advance before data restoration, files that may have been damaged by ransomware can be prevented from being restored to a target device. Furthermore, since a list of candidate files excluding the suspicious files can be quickly obtained for data restoration, the time needed for data recovery and even the human work required are greatly saved.

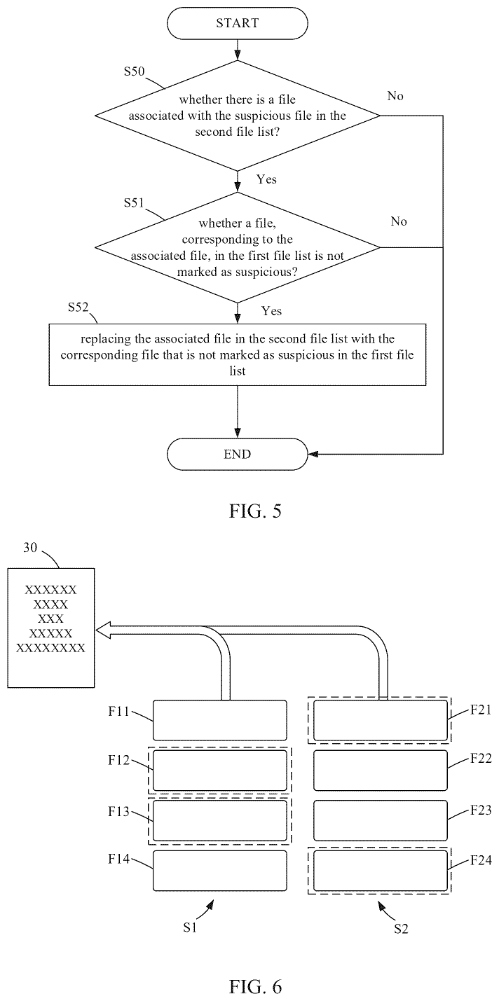

FIG. 5 is a flowchart of a method of generating a candidate file list according to an embodiment of the present application. In the process of generating the candidate file list, in addition to replacing the suspicious files one by one in the second file list with normal files in the first file list, it can also regard all the files associated with a suspicious file in the second file list as a group, and based on the group it can find a corresponding undamaged group in the first file list for the replacement. Therefore, the method may further include detecting whether there is a file associated with the suspicious file in the second file list (Step S50), and detecting whether a file, corresponding to the associated file, in the first file list is not marked as suspicious (Step S51). When there is a file associated with the suspicious file in the second file list and there is an undamaged version of the file corresponding to the associated file in the first file list, the associated file in the second file list can be replaced with the corresponding file that is not marked as suspicious in the first file list to generate the candidate file list (Step S52).

For example, referring to FIG. 6, there is a suspicious file F22 in the second snapshot S2, and the file F23 is a file associated with the suspicious file F22. The files F22 and F23 in the second snapshot S2 can be regarded as a group, which corresponds to the files F12 and F13 in the first snapshot S1, and both the files F12 and F13 are normal files. As a result, the files F12 and F13 in the first snapshot S1 can be used to replace the files F22 and F23 in the second snapshot S2.

The above-mentioned associated file may be a file located in a same folder, a file of a relevant type, a file with dependency, or a file that is modified during a same period, or a combination of any two or more thereof. For example, ransomware may attack files or system files that belong to the same software. The files damaged by ransomware may be related to or dependent on each other. Different snapshots may store files that are not compatible. Therefore, sometimes, it is necessary to restore the files stored in the same snapshot. Only in this way can it ensure a normal function of the software or system. For example, in various database systems (e.g., MySQL, PostgreSQL or Oracle), data files, transaction logs and configuration files are closely related to each other. Backing up or restoring only one part of them without including other parts may result in inconsistency or data loss. Version control systems also have similar demands. For example, Git or Subversion manages repositories including program codes, configuration files, and project histories. To ensure consistency, the backup or restoration should include the entire repository, including associated files of metadata and the branches. Other applications, such as virtual machines, also have the same demands. Virtual machine images include disk files, snapshots and configuration files. Backing up or restoring only a disk image without associated configuration files or snapshots may result in difficulties in restoring the virtual machine consistently.

In addition, ransomware may attack the files located in the same project folder or of the same type. Restoring the files located in the same folder or of the same type together can help business or official work to be restored consistently. In addition, in a ransomware attack, the ransomware may have modified a large number of files during the same period. Therefore, the files that are modified during the same period can be regarded as associated files, which are recorded together in the candidate file list for the restoration. This can ensure consistency between the files.

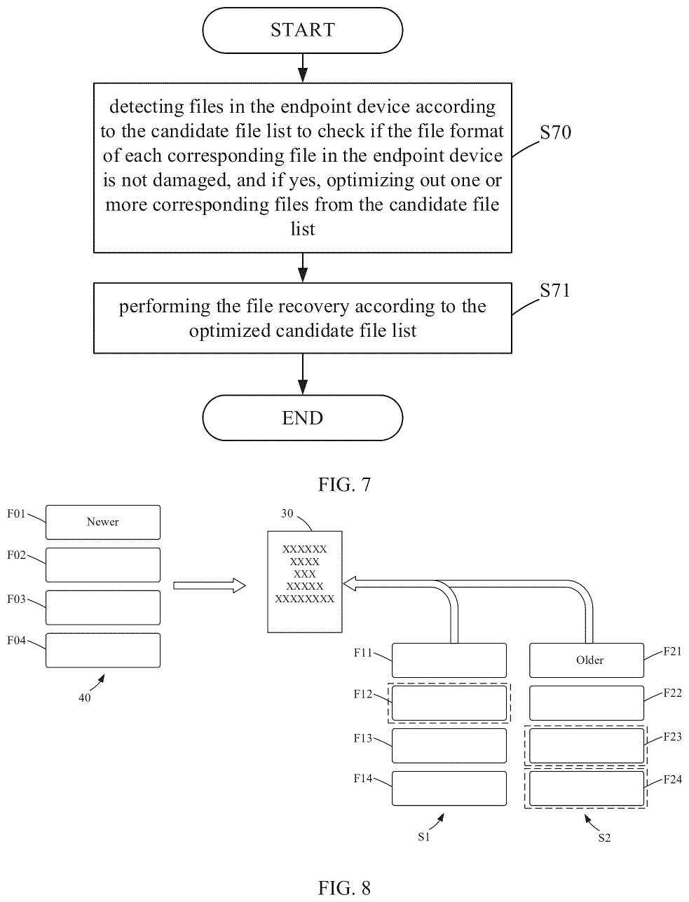

FIG. 7 is a flowchart of a method of optimizing a candidate file list (locally optimized) according to an embodiment of the present application. Not all files on a target device to be restored are damaged by ransomware, and the files that have not been damaged may have newer versions as compared with the files stored in the snapshots, and thus do not need to be restored. Therefore, the method may further include detecting files in the endpoint device according to the candidate file list generated in Step S28 to check if the file format of each corresponding file in the endpoint device is not damaged, and if yes, optimizing out one or more corresponding files from the candidate file list (Step S70). Specifically, the candidate file list may be optimized for the local side so as to remove one or more files from the candidate file list, where the one or more files are determined on the “local” endpoint device (i.e., a target device) as not suspicious. After the optimized candidate file list is obtained by optimizing the candidate file list for the local side, it can perform the file recovery according to the optimized candidate file list (Step S71). Data restoration according to the optimized candidate file list can greatly reduce the number of files that have to be retrieved from each of the snapshots. Meanwhile, newer versions of files can be saved as much as possible, thereby further improving the efficiency of data recovery.

For example, referring to FIG. 8, the files F02, F03, and F04 in the source storage area 40 of a target device are the files damaged by ransomware. Following the previous example, the restoration process will generate the candidate file list from the file F12 of the first snapshot S1 and the files F21, F23, and F24 of the second snapshot S2. However, since the file F01 in the source storage area 40 is a normal file that has not been damaged and is newer than or at least the same version as a corresponding file in the snapshot (e.g., the file F21 of the second snapshot S2), there is no need to restore the file. Based on this, the candidate file list can be optimized for the local side, that is, the file F21 in the snapshot S2 corresponding to the file F01 is removed from the candidate file list.

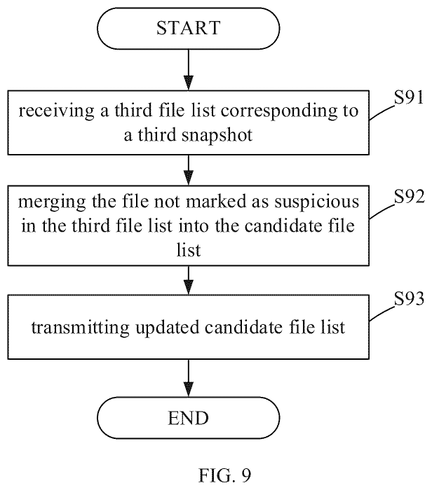

FIG. 9 is a flowchart of a method of updating a candidate file list according to an embodiment of the present application. A file damaged by ransomware in a target device to be restored may not have a corresponding, undamaged file in the candidate file list. In this case, it can introduce one or more file lists from snapshots with earlier backup times. The candidate file list is updated according to the introduced snapshots such that files that can be used for the restoration can be found from the snapshots with earlier backup times. Therefore, the method may further include receiving a third file list corresponding to a third snapshot if the file in the second file list is marked as suspicious (Step S91). The file not marked as suspicious in the third file list can be merged into the candidate file list to generate an updated candidate file list (Step S92). Specifically, if a certain file is marked as suspicious in both the first file list and the second file list, it can find an undamaged version of the file from the third file list to restore the file. Finally, in response to the restoration request, the updated candidate file list is transmitted to the endpoint device (i.e., the target device) (Step S93) such that file recovery can be performed according to the updated candidate file list. According to the updated candidate file list for data restoration, it can find files that can be used for the restoration from the snapshots with earlier backup times. This greatly improves the success of data recovery. It is noted that according to this embodiment, it is easy to extend to include more or earlier snapshots to obtain the latest clean files from all available snapshots as much as possible to generate the candidate file list. This embodiment should not be regarded as a limitation of the present invention.

While the preferred embodiments of the present application have been illustrated and described in detail, various modifications and alterations can be made by persons skilled in this art. The embodiments of the present application are therefore described in an illustrative but not restrictive sense. It is intended that the present 5 application should not be limited to the particular forms illustrated, and that all modifications and alterations which maintain the spirit and scope of the present application are within the scope as defined in the appended claims.

What is claimed is:

1. A method for file recovery based on multiple snapshots, comprising:
receiving multiple files stored on an endpoint device, backing up the files into a first snapshot, and storing a first file list corresponding to the first snapshot;
detecting whether each file of the first snapshot is damaged when backing up the first snapshot, and if a file is damaged, marking the file in the first file list as suspicious;
receiving multiple files stored on the endpoint device, backing up the files into a second snapshot, and storing a second file list corresponding to the second snapshot;
detecting whether each file of the second snapshot is damaged when backing up the second snapshot, and if a file is damaged, marking the file in the second file list as suspicious;
accessing the first file list and the second file list when a restoration request is received from the endpoint device, and replacing the file marked as suspicious in the second file list with a corresponding file not marked as suspicious in the first file list to generate a candidate file list; and
in response to the restoration request, transmitting the candidate file list to the endpoint device to perform file recovery according to the candidate file list.

2. The method of claim 1, further comprising:
detecting whether there is a file associated with the suspicious file in the second file list;
detecting whether a file, corresponding to the associated file, in the first file list is not marked as suspicious; and
replacing the associated file in the second file list with the corresponding file that is not marked as suspicious in the first file list to generate the candidate file list.

3. The method of claim 2, wherein the associated file refers to a file based on one of or a combination of at least two of the following characteristics:
a file located in a same folder, a file of relevant type, a file with dependency, and a file that is modified during a same period.

4. The method of claim 1, further comprising:
detecting files in the endpoint device according to the candidate file list to check if any corresponding file in the endpoint device is not damaged, and if yes, optimizing out the file from the candidate file list; and
performing the file recovery according to the optimized candidate file list.

5. The method of claim 1, wherein detecting whether a file is damaged or whether a file is suspicious is according to at least one of the followings:
whether the file can be opened by a software application;
whether the file can be parsed by a file parser; and
whether file content entropy of the file is too high.

6. The method of claim 1, further comprising:
restoring files from the snapshots to the endpoint device according to the candidate file list.

7. The method of claim 1, further comprising:
restoring files from the snapshots to a second endpoint device other than the endpoint device according to the candidate file list.

8. The method of claim 1, further comprising:
if the file in the second file list is marked as suspicious, receiving a third file list corresponding to a third snapshot;
merging the file not marked as suspicious in the third file list into the candidate file list to generate an updated candidate file list; and
in response to the restoration request, transmitting the updated candidate file list to the endpoint device.

9. The method of claim 1, further comprising:
copying a damaged file to another folder in advance if a backup file retrieved from the snapshots is going to overwrite the damaged file during restoration.

10. The method of claim 1, further comprising:
placing a backup file retrieved from the snapshots into a folder other from the folder of the damaged file on a local side.

11. A system for file recovery based on multiple snapshots, comprising:
a processor; and
a memory connected to the processor, storing a plurality of instructions that can be executed by the processor to:
receive multiple files stored on an endpoint device, back up the files into a first snapshot, and store a first file list corresponding to the first snapshot;
detect whether each file is damaged when backing up the first snapshot, and if a file of the first snapshot is damaged, mark the file in the first file list as suspicious;
receive multiple files stored on the endpoint device, back up the files into a second snapshot, and store a second file list corresponding to the second snapshot;
detect whether each file is damaged when backing up the second snapshot, and if a file of the second snapshot is damaged, mark the file in the second file list as suspicious;
access the first file list and the second file list when a restoration request is received from the endpoint device, and replace the file marked as suspicious in the second file list with a corresponding file not marked as suspicious in the first file list to generate a candidate file list; and
in response to the restoration request, transmit the candidate file list to the endpoint device to perform file recovery according to the candidate file list.

12. The system of claim 11, wherein the plurality of instructions are executed by the processor to:
detect whether there is a file associated with the suspicious file in the second file list;
detect whether a file, corresponding to the associated file, in the first file list is not marked as suspicious; and
replace the associated file in the second file list with the corresponding file that is not marked as suspicious in the first file list to generate the candidate file list.

13. The system of claim 12, wherein the associated file refers to a file based on one of or a combination of at least two of the following characteristics:
a file located in a same folder, a files of relevant type, a file with dependency, and a file that is modified during a same period.

14. The system of claim 11, wherein the plurality of instructions are executed by the processor to:
detect files in the endpoint device according to the candidate file list to check if any corresponding file in the endpoint device is not damaged, and if yes, optimize out one or more corresponding files from the candidate file list; and
perform the file recovery according to the optimized candidate file list.

15. The system of claim 11, wherein detecting whether the file format of the file is damaged or whether the file is suspicious is according to at least one of the followings:
whether the file can be opened by a software application;
whether the file can be parsed by a file parser; and
whether file content entropy of the file is too high.

16. The system of claim 11, wherein the plurality of instructions are executed by the processor to:
restore the files from the snapshots to the endpoint device according to the candidate file list.

17. The system of claim 11, wherein the plurality of instructions are executed by the processor to:
restore the files from the snapshots to a second endpoint device other than the endpoint device according to the candidate file list.

18. The system of claim 11, wherein the plurality of instructions are executed by the processor to:
if the file in the second file list is marked as suspicious, receive a third file list corresponding to a third snapshot;
merge the file not marked as suspicious in the third file list into the candidate file list to generate an updated candidate file list; and
in response to the restoration request, transmit the updated candidate file list to the endpoint device.

19. The system of claim 11, wherein the plurality of instructions are executed by the processor to:
copy a damaged file to another folder in advance if a backup file retrieved from the snapshots is going to overwrite the damaged file during restoration.

20. The system of claim 11, wherein the plurality of instructions are executed by the processor to:
place a backup file retrieved from the snapshots into a folder different from the damaged file.
